(19) United States
(12) Patent Application Publication
(10) Pub. No.: US 2020/0292278 A1
(43) Pub. Date: Sep. 17, 2020

(54) OPTRONIC SYSTEM FOR A PLATFORM AND ASSOCIATED PLATFORM

(71) Applicant: THALES, Courbevoie (FR)

(72) Inventors: Paul THIBOUT, Élancourt (FR); Olivier GARIN, Élancourt (FR)

(21) Appl. No.: 16/605,734

(22) PCT Filed: Apr. 19, 2018
(86) PCT No.: PCT/EP2018/060000

§ 371 Date: Oct. 16, 2019

(30) Foreign Application Priority Data
Apr. 19, 2017 (FR) 17 00430

(51) Int. Cl. F41G 3/22; G01S 7/48; G02B 27/00; F41G 5/24

(52) U.S. Cl. CPC F41G 3/22; G01S 7/4804; G01S 2007/4977; F41G 5/24; G02B 27/0006

(57) ABSTRACT

The invention relates to an optronic system for a platform, the optronic system comprising:
a support that can be rotated about a first axis, the support defining an space;
an optronic head for observing part of the surroundings of the platform, the optronic head being mounted such that it rotates about a second axis, the second axis being perpendicular to the first axis,
a hemispherical viewing device comprising a sensor with an optical system having an at least hemispherical field, the sensor being able to detect images of part of the surroundings of the platform, and a calculator for processing the images that the sensor detects, the calculator being in the inside space and the sensor being secured to the support.

The present invention relates to an optronic system. The present invention also relates to a platform equipped with such an optronic system.

In the field of observation and vehicle protection, it is known to use a short-range observation device with another long-range observation device.

To that end, the short-range observation device includes hemispherical viewing equipment installed on a vehicle.

Such equipment provides an operator of the vehicle with information on the environment outside the vehicle. Among this information, in particular, 360° images are provided in real time with an elevation between 75° and −15°, each point of which is referenced precisely.

In some cases, the equipment is also capable of supplying moving target detection (sometimes referred to using the acronym MTD) information, laser alert detection (sometimes referred to using the acronym LAD) information and missile launch detection (sometimes referred to using the acronym MLD) information.

To try to best cover the entire environment of the vehicle with no hidden zone, several pieces of viewing equipment are typically arranged on the perimeter of the vehicle. This means that images coming from each piece of equipment should be merged to reproduce a single image for the operator.

However, such merging is delicate to perform in real time and involves, by construction, parallax problems and problems related to the presence of blind spots that are particularly bothersome when the pieces of equipment also provide moving target detection, laser alert detection and missile launch detection information.

Furthermore, during the movement of the vehicle, the merging is even more difficult, since there is also a need to compensate for the distortions introduced by such a movement in an image. In particular, when the vehicle is running, the movement creates blurriness in the images to be compensated.

There is therefore a need for an optronic system capable of supplying the aforementioned information in the surroundings of the platform and that is easy to implement.

To that end, the present disclosure describes an optronic system for a platform, the optronic system including a support that can be rotated about a first axis, the support defining an inner space. The optronic system includes an optronic head for observing part of the surroundings of the platform, the optronic head being mounted such that it rotates about a second axis, the second axis being perpendicular to the first axis. The optronic system includes a hemispherical viewing device comprising a sensor with an optical system having an at least hemispherical field, the sensor being able to detect images of part of the surroundings of the platform, and a calculator for processing the images that the sensor detects, the calculator being in the inner space and the sensor being secured to the support.

According to specific embodiments, the optronic system comprises one or more of the following features, considered alone or according to all technically possible combinations:
the sensor is positioned on a mechanical interface, the mechanical interface being fastened on the support.
the support includes two lateral arms and a base, the mechanical interface being fastened on each lateral arm.
the calculator is capable of supplying moving target detection information, laser alert detection information and missile launch detection information.
the optronic system is provided with a protective shield independent of the support.
the optronic system is provided with a device for cleaning the hemispherical viewing device, the cleaning device including a spray nozzle, the spray nozzle being positioned on the shield.
the calculator is capable of operating at a pace greater than 1 Gigabit per second.
the sensor includes a matrix detector located in the focal plane of the optical system, means for displaying images processed by the sensor, the matrix detector being at video rate and comprising L×C pixels, with L and C>2000, each pixel being double sampling correlated and suitable for ensuring a charge-voltage conversion, and 2 C parallelized analog-digital conversion (or ADC) elements, each conversion element in turn including a first ADC with an output having a low level and high gain and a second ADC with an output having a high level and low gain, the optical system having a focal distance controlled as a function of the angle of elevation, the focal distance being the longest in the equatorial plane, and has a numerical aperture of between 0.9 and 1.6, the calculator comprising means for correcting nonuniformities of the detector using correction tables adopted as a function of the temperature and the exposure time of the detector, weighted summing means, for several adjacent pixels, means for adapting the dynamics of the captured image to the dynamics of the scene, means for compressing the dynamics of the captured image as a function of the temporal noises of the detector, increasing with the illumination of the scene, means for adapting the dynamics of the captured image to the dynamics of the display and/or to those of the eye.
the calculator includes means for controlling the exposure time, the gain and the image rate of the detector as a function of the surrounding conditions, means for stabilizing the image as a function of the movements of the system or display means, means for detecting newly exposed regions of the scene, for detecting and tracking events or movements in the scene, for embedding information coming from other interfaces in the displayed image.
the optical system includes a plurality of objectives having a less extensive field than a hemispherical field.
the sensor includes a plurality of detectors each equipped with an optic, the set of optics forming the optical system.

The present disclosure also relates to a platform including optronic system as previously disclosed.

According to specific embodiments, the platform comprises one or more of the following features, considered alone or according to any technically possible combinations:
the optronic system is unique.
the platform has a wall, the support being positioned on the wall.
the platform is a vehicle including a turret, the support being positioned on the turret.

Other features and advantages of the invention will appear upon reading the following description of embodiments of the invention, solely as an example and done in reference to the drawings, which are:

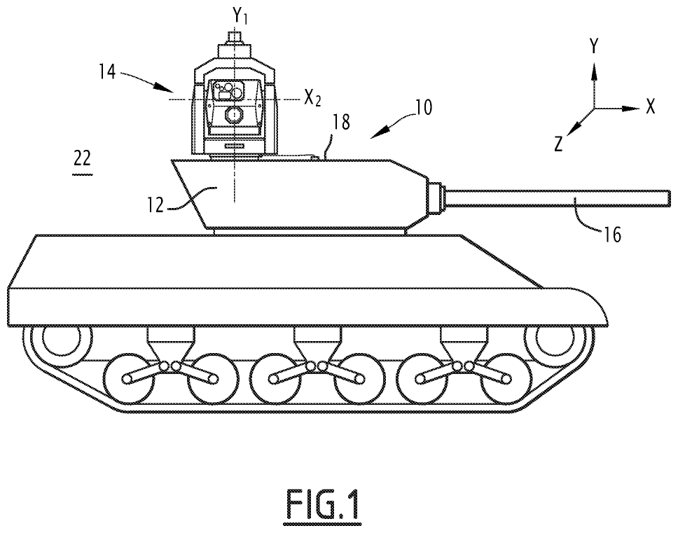

FIG. 1, a schematic view of a vehicle provided with an exemplary optronic system, and

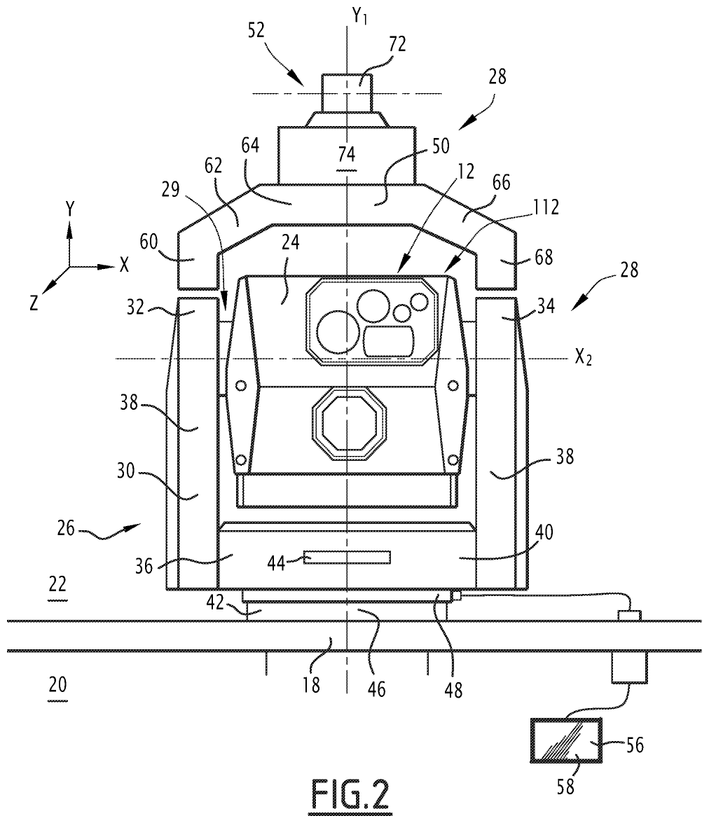

FIG. 2, a schematic side view of the optronic system of FIG. 1.

FIG. 1 shows a vehicle 10.

The vehicle 10 is a land vehicle.

For example, the vehicle 10 is a military-type vehicle such as a tank.

Such a vehicle 10 is suitable for having a plurality of weapons and protecting at least one operator installed inside the vehicle 10.

According to the described example, the vehicle 10 is provided with a turret 12 on which part of an optronic system 14 is positioned.

For example, the turret 12 is further provided with a firing cannon 16.

The vehicle 10 includes a wall 18 delimiting an inner space 20 from an outer space 22.

More specifically, in the military context, the inner space 20 is the space to be secured, since it is the space in which the operator(s) will move while the outer space 22 is the operating theater in which safety is more difficult to guarantee depending on the considered surroundings.

The wall 18 is made from a material strong enough to form armor of the vehicle 10, the vehicle 10 having to withstand shots.

The optronic system 14 is described more specifically in reference to FIG. 2.

For convenience, directions are defined.

A direction normal to the wall 18 is symbolized by an axis Y in FIG. 2. This direction corresponds to the relative bearing direction and will be called relative bearing direction Y in the remainder of the description.

A first transverse direction is also defined located in the plane of FIG. 2, the first transverse direction being perpendicular to the relative bearing direction. This direction is symbolized by an axis X in FIG. 2. This direction corresponds to the elevation direction and will be called elevation direction X in the remainder of the description.

A second transverse direction is also defined, symbolized by an axis Z in FIG. 2. The second transverse direction Z is perpendicular to the relative bearing direction Y and the elevation direction X.

The optronic system 14 includes an optronic head 24, a support 26 and a hemispherical viewing device 28.

The optronic head 24 is an optronic head 24 for observing a part of the environment of the outer space 22 of the vehicle 10.

The optronic head 24 for example includes cameras able to capture the visible light, in black-and-white and/or in color, infrared cameras, telemeters, or pointers. The videos and the data collected by the optronic head 24 are sent to the interior of the vehicle 10 by means of analog and/or digital signals.

In this sense, the optronic head 24 is an optronic head 24 with indirect view, that is to say, an optronic head 24 providing a view via a screen that assumes the operation of all of the elements involved in the viewing of the scene on the screen.

The support 26 is positioned on the turret 12.

The support 26 is movable about a first axis Y1, the first axis Y1 being parallel to the relative bearing direction Y.

The support 26 is intended to keep the optronic head 24 movable relative to a second axis X2. The optronic head 24 is mounted rotating on the support 26 about the second axis X2.

According to the illustrated example, the second axis X2 is parallel to the elevation direction X.

The support 26 includes a wall that makes it possible to delimit an inner space 30.

The support 26 includes two lateral arms 32, 34 and a base 36.

The two lateral arms 32, 34 and the base 36 are arranged to form a substantially U-shaped part.

In the specific example of FIG. 2, the two lateral arms 32, 34 are identical.

Each of the two lateral arms 32, 34 is located on either side of the optronic head 24 to provide the maintenance of the optronic head 24.

Each of the lateral arms 32, 34 extends primarily along the relative bearing direction Y.

The wall of each lateral arm 32, 34 is made from an alloy with a base of aluminum or any other material.

For each of the lateral arms 32, 34, an inner space 30 called lateral space 38 is defined.

According to the illustrated example, each lateral arm 32, 34 has a substantially parallelepiped shape.

The base 36 has two parts: a central part 40 connecting the two lateral arms 32, 34 and an interfacing part 42 with the wall 18.

The central part 40 is hollowed out such that a central volume 44 can also be defined for the central part 40.

In the case at hand, the inner space of the support 26 is therefore the sum of the lateral volumes 38 and the central space 44.

The interfacing part 42 is a mechanical interface having, according to the case of FIG. 2, a cylinder shape with a hollowed out central part 40, the interfacing part 42 delimiting an inner space 46.

The interfacing part 42 supports an interface 48 delimiting the inner space 46. The shape of the interface is chosen so as to adapt to the shape of the optronic head 24.

The volume delimited by the sum of the inner space 46 of the interface 42 and the central space 44 of the central part 40 includes motors, resolvers intended to command the motors, as well as an electric rotary joint and/or an optical fiber that are capable of transmitting signals or data between the optronic head 24 and the inside of the vehicle 10.

The motors are capable of driving a rotational movement of the support 26 relative to the wall 18 around the first axis Y1.

The interfacing part 42 is, according to the embodiments, stationary or a lift. In the case of FIG. 2, the interfacing part 42 is stationary.

The hemispherical viewing device 28 includes a mechanical interface 50, a sensor 52, a calculator 54, a display unit 56 and a man-machine interface 58.

The mechanical interface 50 is fastened on the rotating support 26.

The mechanical interface 50 is secured to the rotating support 26.

In the proposed example, the mechanical interface 50 is fastened on each lateral arm 32, 34.

According to the example of FIG. 2, the mechanical interface 50 includes five parts: a first end part 60, a first intermediate part 62, a median part 64, a second intermediate part 66 and a second end part 68.

The first intermediate part 62 connects the first end part 60 to the median part 64 while the second intermediate part 66 connects the second end part 68 to the median part 64.

Each end part is connected to a respective lateral arm 32, 34.

The sensor 52 is able to detect images of part of the surroundings of the vehicle 10.

The sensor 52 is fastened on the median part 64 of the mechanical interface 50 by holding bars. The bars are not shown in the figures for the sake of clarity of these figures.

For example, the sensor 52 is fastened by three holding bars.

In the described example, the holding bars are evenly distributed at 120°.

The median part 64 being secured to the support 26, the sensor 52 is secured to the support 26.

The sensor 52 corresponds to the highest point of the optronic system 14. The distance between the sensor 52 and the wall 18 along the axis Z makes it possible to define the height of the optronic system 14. In the described example, the height of the optronic system 14 is less than 1 meter.

The sensor 52 includes an optical system 72 with a hemispherical field and a detector 74.

According to one variant, the sensor 52 includes a plurality of detectors 74 each equipped with an optic, the set of optics forming an optical system 72 with hemispherical field.

In the illustrated case, the optical system 72 has a field covering an angular range greater than or equal to a hemisphere, the axis of which is oriented toward the zenith.

For this reason, the optical system 72 is qualified as optical system 72 with “hemispherical field”. This expression means that the field covered by the optical system 72 is greater than or equal to a hemisphere. The term “supra-hemispherical field” is sometimes used to refer to this concept.

The optical system 72 has a large opening.

The optical system 72 has a variable resolution in the field.

According to one particular embodiment, the optical system 72 has major distortions in order to offer enhanced resolutions in certain angular domains, for example in the equatorial plane, to increase the range of the optic.

For example, the optical system 72 includes a fisheye lens, shortened to fisheye, or a hypergon lens having a focal length of 4.5 mm (millimeters) and 12 pixels per degree. The optical system 72 then includes one or two lenses as previously described to cover a field of 360°.

According to another example, the optical system 72 includes a plurality of objectives having a less extensive field than a hemispherical field. As an illustration, the optical system 72 is a set of three fisheye lenses, each lens having a focal length of 8 mm and 21 pixels per degree over 120°.

According to still another example, the optical system 72 is an optic with a very large distortion making it possible to cover a field of 360°, with a variable radial resolution along the angle of elevation that may range from 20 to 22 pixels/° or more in radial resolution.

The detector 74 is a matrix of photodetectors making it possible to define pixels.

The detector 74 is located in the focal plane of the optical system 72.

For example, the detector 74 is a 4T CMOS matrix (with 4 transistors in the pixel) or more, operating at 25 Hz, with low noise (less than 2 electrons) and high dynamics (greater than 80 dB).

Each pixel has correlated double sampling and the charge-voltage conversion is done in each pixel, which ensures that the detector 74 has a very low noise level and high instantaneous dynamics.

Furthermore, the monitoring of the exposure (or integration) time, from durations shorter than 10 ps to durations of 40 ms, for example, allows the detector 74 to operate day and night. In a nighttime atmosphere, at a very low level, it is possible to increase the exposure time for example to 100 ms and to reduce the image rate for example to 10 Hz in order to improve the signal-to-noise ratio of the reproduced image.

The calculator 54 is suitable for processing the images that the sensor 52 can detect in order to obtain information on the surroundings of the vehicle 10.

Typically, the calculator 54 is can process data having a size of several Gigabits per second.

Thus, the calculator 54 is capable of operating at a pace greater than or equal to 1 Gigabit per second.

In the described example, among the information that the calculator 54 can obtain, there is the moving target detection information, laser alert detection information and missile launch detection information.

The calculator 54 is in the inner space.

More specifically, the calculator 54 is in the inner space of the base 36, therefore positioned before the rotary joint.

The display unit 56 can display images processed by the calculator 54.

The display unit 56 is positioned in the inner space 20.

The man-machine interface 58 allows an operator to control the hemispherical viewing device 28.

The man-machine interface 58 is positioned in the inner space 20.

According to the example of FIG. 2, the display unit 56 and the man-machine interface 58 are combined.

The operation of the optronic system 14 will now be described.

During operation, the optronic system 14 has several functions: on the one hand, owing to the optronic head 24, the optronic system 14 makes it possible to observe part of the scene by using different cameras able to produce images in different spectral bands owing to the different cameras, for example in the visible spectrum, and in the infrared (radiation whereof the wavelength is between 800 nanometers and 14 micrometers). The cameras in particular make it possible to produce images in the following domains: NIR, SWIR, IR2 (wavelength between 3 micrometers and 5 micrometers) and IR3 (wavelength between 7.5 micrometers and 14 micrometers).

When the operator commands a rotation around the first axis Y1 of the support 26 maintaining the optronic head 24, the support 26 rotates and the observer can observe another part of the scene.

Furthermore, owing to the hemispherical viewing device 28, the calculator 54 has additional information on the surroundings of the vehicle 10. In the case at hand, the calculator 54 is able to supply real-time 360° images with an elevation of between 75° and −15° (or more in high elevation and less in low elevation), each point of which is referenced precisely. The calculator 54 is also capable of supplying moving target detection information, laser alert detection information and missile launch detection information.

The specific positioning of the hemispherical viewing device 28 provides the possibility for the hemispherical viewing device 28 of observing the surroundings of the vehicle 10 without concealment. In particular, the hemispherical viewing device 28 is the highest point of the vehicle 10, which limits the concealment by other elements of the vehicle 10.

Furthermore, such positioning makes it possible to better cover the off-axis illumination, which results in improved laser alert detection.

The positioning on the rotating support 26 also ensures rotational stabilization of the sensor 52 (mechanical slaving in relative bearing). The scrolling phenomenon of the image due to the rotational movement of the vehicle 10 or the turret 12 is thus greatly reduced.

The proposed optronic system 14 includes a single hemispherical viewing device 28, which avoids positioning a plurality of hemispherical viewing devices.

This results in increased space on the vehicle 10 as well as a gain in terms of weight.

Furthermore, this avoids the difficulty of having to merge images coming from hemispherical viewing devices.

The optronic system 14 includes a single calculator 54, which simplifies the information transfers. In particular, all of the information is centralized in a single place. The simplification of the information transfers implies a decrease in the connections to be made, which also results in a gain in terms of weight for the vehicle 10.

The optronic system 14 is thus capable of operating with a high refresh frequency.

The calculator 54 further has access to additional information, namely the position of the rotating support 26, which makes it possible to optimize the quality of the information supplied by the optronic system 14.

The position of the calculator 54 also makes it possible to greatly reduce the heat signature of the optronic system 14.

The position on the rotating support 26 also grants a possibility of rotating the optical system 72 to make areas of the environment visible that would be concealed by the holding bars of the sensor 52.

The possibility of rotating the sensor 52 in relative bearing makes it possible to consider other embodiments using such a possibility.

For example, a slow rotation relative bearing of the rotating support 26 makes it possible to consider super-resolution techniques on an axis for the hemispherical viewing device 28.

This makes it possible to further increase the quality of the information supplied by the calculator 54.

According to another example, the optronic system 14 is provided with a protective shield independent of the rotating support 26.

The shield is a protective shield protecting the optical system 72 while leaving just the optical system 72 without concealment. The protection of the shield makes it possible to protect against fragments created by an explosion or against fired bullets. It should be noted that the shield also makes it possible to reduce the heat signature of the optronic system 14.

For this shield, it is also possible, according to one particular embodiment, to use the rotation of the optic. Thus, the optronic system 14 is provided with a system for cleaning the hemispherical viewing device, the cleaning device including a spray nozzle, the spray nozzle being positioned on the shield.

The spray nozzle is stationary and able to send a water jet, for example.

In a variant, the spray nozzle is able to send an air jet.

The cleaning of the optical system 72 is done by rotating the support.

Other embodiments can also be considered for the proposed optronic system 14.

According to one embodiment, the optical system 72 includes a single fisheye lens. This makes it possible to simplify the connections and to use simpler image processing operations.

According to another embodiment, the optical system 72 includes a plurality of separate optics.

Furthermore, the optronic system 14 is able to operate on a plurality of spectral bands, for example in the visible spectrum, and in the infrared (radiation whose wavelength is between 800 nanometers and 14 micrometers). For example, the optronic system 14 works on the following spectral bands. NIR, SWIR, IR2 (wavelength between 3 micrometers and 5 micrometers) and IR3 (wavelength between 7.5 micrometers and 14 micrometers). To that end, the optronic system 14 for example includes a sensor 52 working on a first spectral band and an optronic head 24 working on a second spectral band, the second spectral band being separate from the first spectral band.

According to still another embodiment, the optronic system 14 includes both components making it possible to ensure the passive imaging and those for the active imaging.

In each of the described embodiments, the optronic system 14 is able to supply information on the environment of the vehicle 10, in particular real-time 360° images with an elevation of between 75° and −15° (or more), each point of which is referenced precisely, moving target detection information, laser alert detection information and missile launch detection information. The optronic system 14 is further easy to implement.

The proposed optronic system 14 is usable on non-armored vehicles, ships, helicopters, airplanes or buildings. The preceding examples are jointly referred to using the generic term “platform”.

In general, the platform includes a wall 18 on which the support 26 is positioned. When the platform includes a part of the wall 18 corresponding to the highest location for the platform, the support 26 is advantageously positioned on said wall part 18 to benefit from the clearest possible field of view. In the described example, the wall part corresponds to the turret 12.

The present invention covers all technically possible combinations of the embodiments that have been described above.

1. An optronic system for a platform, the optronic system including:
a support that can be rotated about a first axis, the support defining an inner space,
an optronic head for observing part of the surroundings of the platform, the optronic head being mounted such that it rotates about a second axis, the second axis being perpendicular to the first axis,
a hemispherical viewing device comprising a sensor with an optical system having an at least hemispherical field, the sensor being able to detect images of part of the surroundings of the platform, and a calculator for processing the images that the sensor detects, the calculator being in the inner space and the sensor being secured to the support.

2. The optronic sensor according to claim 1, wherein the sensor is positioned on a mechanical interface, the mechanical interface being fastened on the support.

3. The optronic system according to claim 2, wherein the support includes two lateral arms and a base, the mechanical interface being fastened on each lateral arm.

4. The optronic system according to claim 1, wherein the calculator is capable of supplying moving target detection information, laser alert detection information and missile launch detection information.

5. The optronic system according to claim 1, wherein the optronic system is provided with a protective shield independent of the support.

6. The optronic system according to claim 5, wherein the optronic system is provided with a device for cleaning the hemispherical viewing device, the cleaning device including a spray nozzle, the spray nozzle being positioned on the shield.

7. The optronic system according to claim 1, wherein the calculator is capable of operating at a pace greater than 1 Gigabit per second.

8. The optronic system according to claim 1, wherein the optical system includes a plurality of objectives having a less extensive field than a hemispherical field.

9. The optronic system according to claim 1, wherein the sensor includes a plurality of detectors each equipped with an optic, the set of optics forming the optical system.

10. A platform including an optronic system according to claim 1.

11. The platform according to claim 10, wherein the optronic system is unique.

12. The platform according to claim 10, the platform being a vehicle including a turret, the support being positioned on turret.
